(19) United States
(12) Patent Application Publication
(10) Pub. No.: US 2008/0282185 A1
(43) Pub. Date: Nov. 13, 2008

(54) CUSTOMIZED MESSAGES FOR PASSWORD/PASSCODE CHANGE EVENTS

(75) Inventors: OSCAR J. BLASS, BOYNTON BEACH, FL (US); PATRICK COMMARFORD, DELRAY BEACH, FL (US); RODRIGO J. PASTRANA, DELRAY BEACH, FL (US); ROBERTO VILA, HOLLYWOOD, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/747,677

(22) Filed: May 11, 2007

(51) Int. Cl. G06F 3/048; G06F 15/16

(52) U.S. Cl. 715/780; 709/206

(57) ABSTRACT

The present invention discloses a method and system for notifying a user of a password/passcode change event. In the invention, a computing system can automatically detect a password/passcode change event. At least one user affected by the event can be determined. A pre-existing user defined message can be retrieved from a data store. A password/passcode change message can be automatically conveyed to the affected user. The change message can include content of the pre-existing user defined message. Further, in one embodiment, an automatically generated activity report associated with a password/passcode can be presented to either a user making a password/passcode change or as part of the conveyed change message.

### BACKGROUND

1. Field of the Invention

The present invention relates to the field of authentication systems, and, more particularly, to customized messages for password/passcode change events.

2. Description of the Related Art

Many different types of security systems utilize many variants of passwords and passcodes to prevent unauthorized users from accessing a secured resource. For example, secure Web sites often require users to provide a valid user name and password before access is granted. Many security gates include a passcode which must be properly entered before the gate opens. Regardless of the type of security system and/or password used for authentication, these passwords/passcodes are often changed. For instance, many computer systems require users to change their passwords every couple of months. In another instance, security personnel routinely change door/gate passcodes when previously authorized employees leave a company and are no longer granted entry to a secured location.

Whenever a password changes, all affected individuals need to be notified of this change. A number of notification systems currently exist, such as those that send email notices to a set of affected users. Users often have to perform one or more actions whenever a password changes. For example, a home owner who receives a notification that a security code that opens a community gate has changed may have to contact a cleaning service, a nanny, a family member, and the like to inform them of the new security code. In another example, a user may have to change one or more passwords on a remote computing machine, which is synchronized with a changed Web site password to make it easier for the user to remember a proper password.

At present, security systems/processes rely on external documentation or individual memories to ensure that actions to be taken in an event of a password change occur. It is extremely easy for individuals responsible for multiple passwords to forget to perform one or more tasks related to a password change. As a result, a period of unreliability and/or instability often follows a password change event. No known system/process exists that permits users to establish a customized message to be automatically presented to users in conjunction with a password change event.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a diagram illustrating a set of flowcharts 110, 130, and 150 for providing customized messages responsive to password/passcode change events in accordance with an embodiment of the inventive arrangements disclosed herein.

FIG. 2 is a schematic diagram illustrating a system 200 in which customized messages for password/passcode change notifications are provided in accordance with an embodiment of the inventive arrangements disclosed herein.

FIG. 3 shows a notification configuration interface 300 for users to customize messages to be presented when a password/passcode changes in accordance with an embodiment of the inventive arrangements disclosed herein.

FIG. 4 shows a sample activity report in accordance with an embodiment of the inventive arrangements disclosed herein.

### DETAILED DESCRIPTION OF THE INVENTION

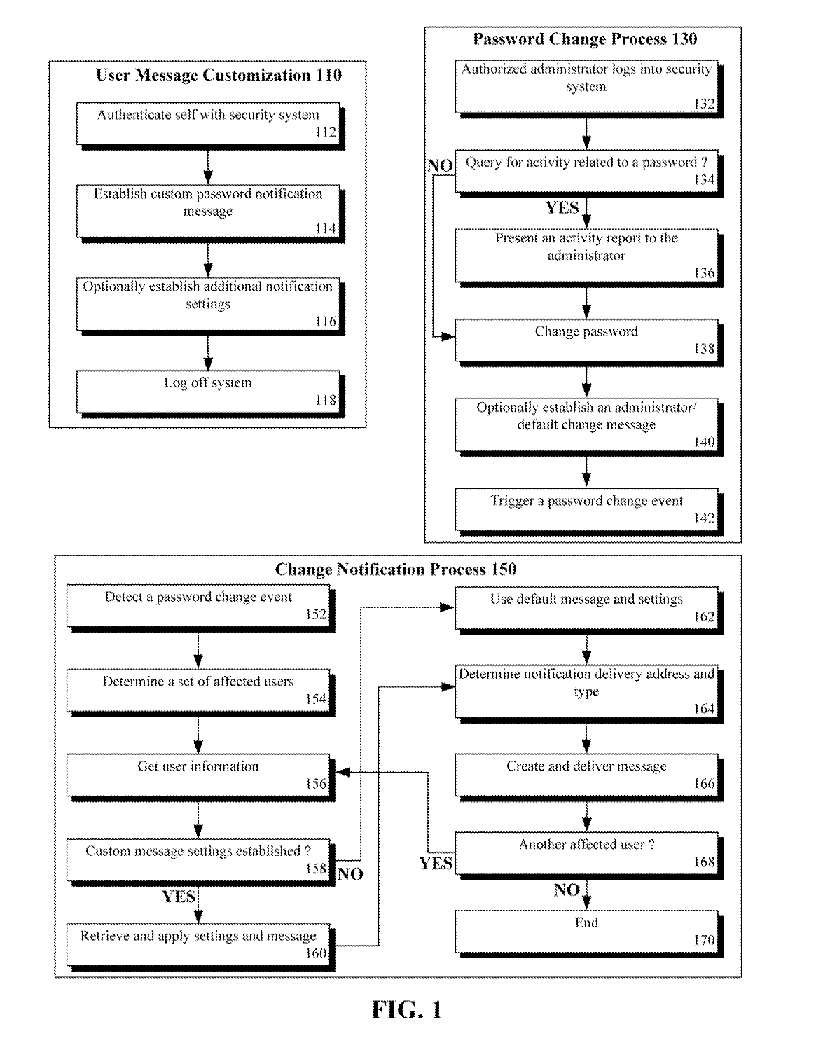

FIG. 1 is a diagram illustrating a set of flowcharts 110, 130, and 150 for providing customized messages responsive to password/passcode change events in accordance with an embodiment of the inventive arrangements disclosed herein. As used herein, password/passcodes are used interchangeably and represent any type of authentication information, such as an alphanumeric sequence, a digital certificate, a public/private key combination, a biometric input, and the like. The password/passcode can even include a physical object, such as a physical key and/or Radio Frequency Identification (RFID) tag, which may have to be physically modified and/or replaced whenever a “password/passcode” change occurs. As shown, flowchart 110 illustrates a user message customization process, flowchart 130 illustrates a password change process, and flowchart 150 illustrates a change notification process 150.

The user message customization 110 flowchart can begin in step 112, where a user can provide authentication information to a security system. In step 114, the user can establish a customized password notification message. The message can include free-form text, automated generated messages, user provided media content, and any other information that the user cares to provide. Commonly, the message will be a text message which will include reminders of actions that the user should take whenever the associated password changes. In step 116, the user can optionally establish additional notification settings, such as a notification address, notification means (e.g., email, fax, phone, etc.), and other related settings. The optional settings and the customized notification message can be stored by the security system. In step 118, the user can log off the system.

The password change process 130 flowchart can begin in step 132, where an authorized administrator can log into the security system. The authorized administrator can be a user of process 110 or any other authorized individual. Step 134 is an optional step where the administrator can query for activity related to a particular password. When the query is performed, the process can progress to step 136, where an activity report can be generated and presented to the administrator. The activity report can include access points, times, dates, user identifiers, and other information stored by the security system that relates to the password. This activity report can be used by the administrator to ensure that all affected individuals are informed of a password change and to potentially provide the administrator with information that may affect whether the administrator chooses to change the password.

In step 138, the administrator can perform a programmatic action, which changes the password. In step 140, the administrator can optionally establish a default password change message. In one embodiment, this administrator provided message can be provided to all affected users, who can also be provided with their customized messages. In another embodiment, user established settings (e.g., from step 116) can determine whether or not an administrator provided message is to be included in a password change message sent to that user. In step 142, a password change event can be triggered.

The change notification process 150 flow chart can begin in step 152, where a password change event can be detected. In step 154, a set of users affected by the password change can be determined. In step 156, information for a first affected user can be acquired. In step 158, a determination can be made as to whether the current user has previously established user-specific password change messages (i.e., whether the user previously performed the steps of flowchart 110). If so, the process can continue to step 160, where user specific settings and messages can be retrieved and applied. Otherwise, step 162 can execute, where a default notification message and/or settings can be applied.

In step 164, a notification delivery address and type can be determined. Delivery types can include email notifications, fax notifications, phone notifications, postal mail notifications, and the like. In step 166, a password change message can be created and delivered to the delivery address. In step 168, a determination can be made as to whether additional affected users exist. If so, the process can loop to step 156, where information for the next affected user can be retrieved. If no more affected users exist, the change notification process can end in step 170.

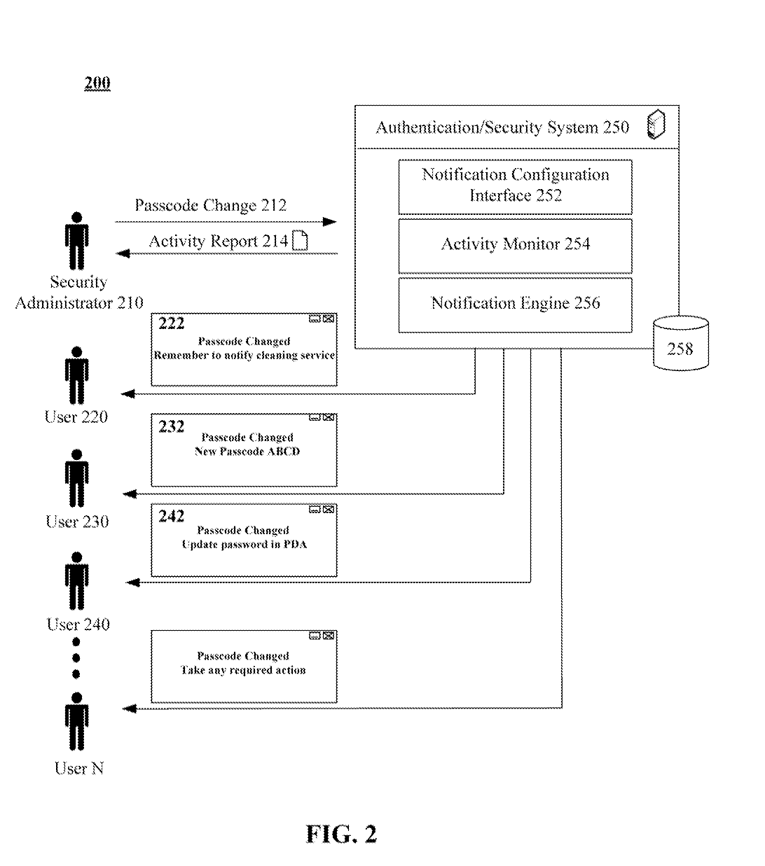

FIG. 2 is a schematic diagram illustrating a system 200 in which customized messages for password/passcode change notifications are provided in accordance with an embodiment of the inventive arrangements disclosed herein. System 200 illustrates a scenario in which a security administrator 210 is able to change a passcode which multiple users 220-240 utilize. For example, the passcode can be a passcode to a security gate or door which requires a proper passcode to open.

In system 200, a security administrator 210 can provide a passcode change 212 to an authentication/security system 250. In one embodiment, the security administrator 210 can receive an activity report 214 from the system 250 either before or after the change is performed. The activity report 214 can provide information about recent activity relating to recent usages of the passcode. This usage information can assist the administrator 210 in making decisions regarding whether to make the passcode change 212 and/or information to assist the administrator 210 in taking actions after making the change 212. An activity monitor component 254 of the system 250 can be used to generate the activity report 214 and/or to manage or gather information that is used to generate the report 214. In one embodiment, the activity monitor report 254 can be configured by an administrator 210 or authorized user 220-240 to provide customized reports 214.

The authentication/security system 250 can be any system that manages a secure resource and passwords for accessing the secure resource. The system 250 can manage/control passcodes, passwords, certificates, keys for protected software, gates, doors, locks, devices, and the like. The authentication/security system 250 can include a notification configuration interface 252, which each user 220-240 is able to use to establish customized notification messages which are stored in the passcode notification store 258. A notification engine 256 of the system 250 can automatically generate and/or deliver change notification messages 222, 232, and/or 242 responsive to detecting a passcode change 212 event.

The notification messages 222, 232, and/or 242 delivered to associated users 220, 230, and/or 240 can be customized for each user 220-240. For example, message 222 can inform user 220 that a passcode has changed and that the user 220 needs to notify his/her cleaning service of the change. Message 232 can notify user 230 that a passcode has changed to ABCD, where ABCD is the new passcode. Message 242 can notify the user 240 that the passcode has changed and that the user 240 needs to update a password manager of their PDA to reflect the change.

The different messages 222, 232, and/or 242 can be delivered in different manners including, but not limited to, email, postal mail, voice mail, a system notification message, a facsimile message, a telephone call, and the like. User 220-240 established (via interface 252) messages and/or parameters can be maintained in data store 258 and can be accessed by the notification engine 256, which adjusts programmatic settings and actions in accordance with the information in data store 258.

The data store 258 can be a physical or virtual storage space configured to store digital information. Data store 258 can be physically implemented within any type of hardware including, but not limited to, a magnetic disk, an optical disk, a semiconductor memory, a digitally encoded plastic memory, a holographic memory, or any other recording medium. Data store 258 can be a stand-alone storage unit as well as a storage unit formed from a plurality of physical devices. Additionally, information can be stored within data store 258 in a variety of manners. For example, information can be stored within a database structure or can be stored within one or more files of a file storage system, where each file may or may not be indexed for information searching purposes. Further, data store 258 can utilize one or more encryption mechanisms to protect stored information from unauthorized access.

The components of system 200 can be communicatively linked to each other via a network (not shown). The network can include any hardware/software/and firmware necessary to convey data encoded within carrier waves. Data can be contained within analog or digital signals and conveyed though data or voice channels. The network can include local components and data pathways necessary for communications to be exchanged among computing device components and between integrated device components and peripheral devices. The network can also include network equipment, such as routers, data lines, hubs, and intermediary servers which together form a data network, such as the Internet. The network can also include circuit-based communication components and mobile communication components, such as telephony switches, modems, cellular communication towers, and the like. The network can include line based and/or wireless communication pathways.

Further, the arrangements shown in system 200 are for illustrative purposes only and are not intended as limiting constraints upon the disclosed invention. For example, the system 250, although illustrated as a stand-alone system can be a distributed system, which together manages/maintains/changes access codes. The system 250 can be an automated system, a semi-automated system, and/or a manual system. For example, when implemented as a semi-automated system, security personnel can be required to manually change a passcode/password in a device/lock whenever an associated passcode/password is changed within the system 252. Further, the passcode notification engine 256 and store 258 need not be directly integrated to system 250, but can instead be a remotely located and potentially independently maintained and operated system, which provides a password/passcode change notification service. When the engine 256 and/or store 258 are separate from system 250, the system 250 will have to convey passcode change 212 events to the engine 256 in some fashion, such as over a network connection.

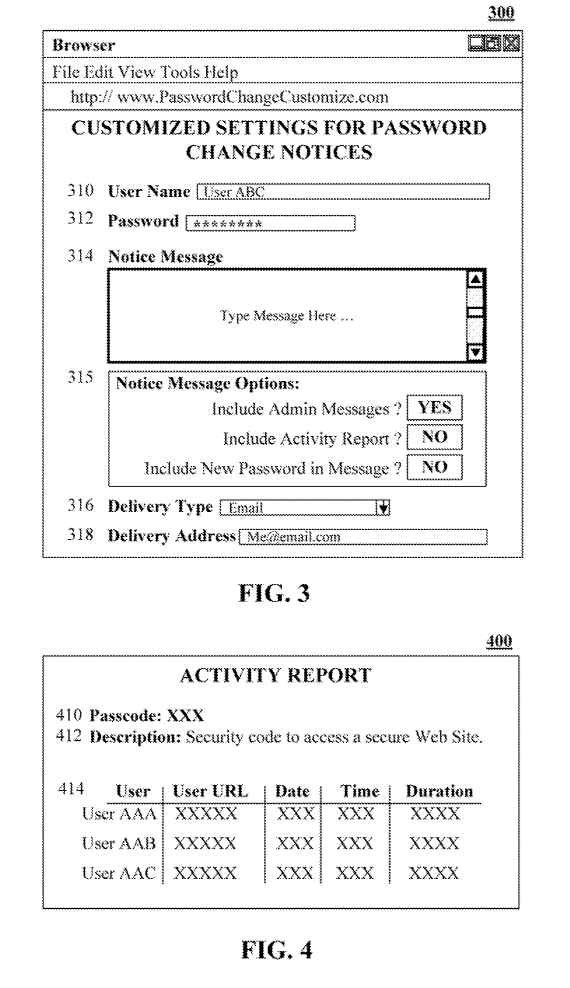

FIG. 3 shows a notification configuration interface 300 for users to customize messages to be presented when a password/passcode changes in accordance with an embodiment of the inventive arrangements disclosed herein. The interface 300 can present one contemplated embodiment for the interface 252 of system 200. Specifics shown in the interface 300 are for illustrative purposes only and the invention is not to be limited in this regard. For example, the graphical user interface (GUI) elements, arrangements, controls, and the like, can be different than those shown within interface 300, yet still be within the scope of the disclosed invention. Further, although a GUI interface is shown, the notification interface 300 can be a voice user interface (VUI), such as a telephone interface, in another contemplated embodiment of the disclosed invention.

The interface 300 can include a user identification element 310, a password element 312, a message element 314, message options 315, a delivery type element 316, a delivery address element 318, and the like. A user can authenticate themselves with a security system using elements 310 and 312. A user can type a customized message in message element 314, which is included in any password/passcode change notice that is sent to a user of the interface 300. The message options 315 can include options such as whether a new password is to be included in a notice, whether an activity report is to be attached to a notice, and whether administrator provided messages are to be included in a notice. Available options 315 can depend upon an interface 300 user's access level (e.g., administrator, supervisor, user, guest, etc.) for the security system. The delivery type 316 and delivery address 318 can specify where and how password change notices are to be sent.

FIG. 4 shows a sample activity report 400 in accordance with an embodiment of the inventive arrangements disclosed herein. The activity report 400 can be a sample of a report 214 of system 200. The report 400 is provided for illustrative purposes only and the invention is not to be construed as limited to its precise arrangements. As shown, the activity report 400 can specify a passcode/password 410 to which the report applies and can include a description 412, and an access table 414. The access table 414 can include a set of records, each record indicating a user, user access point, an access date and time, an access duration, and other such attributes.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for notifying a user of a password/passcode change event comprising:
a computing system automatically detecting a password/passcode change event;
determining at least one user affected by the password/passcode change event;
retrieving a pre-existing user defined message from a data store; and
automatically conveying a change message that includes the pre-existing user defined message to the determined user.

2. The method of claim 1, wherein the at least one user comprises a plurality of users, wherein each of the plurality of users is associated with a different user defined message, said method further comprising:
automatically conveying a change message to each of the plurality of users, wherein each change message includes a user defined message associated with the user to which the change message was conveyed.

3. The method of claim 1, wherein the change message is at least one of an email message, a postal message, a telephone message, and a facsimile message.

4. The method of claim 1, wherein the conveying step conveys the change message to a user defined delivery address.

5. The method of claim 1, wherein the conveying step conveys the change message using a user defined delivery mechanism selected from one of email, postal mail, a telephone communication, and a facsimile message.

6. The method of claim 1, wherein the user defined message specifies a series of actions to be taken by the user responsive to the password/passcode change event.

7. The method of claim 1, wherein the change message include a new password/passcode.

8. The method of claim 1, wherein the change message includes an activity report, wherein said activity report is a system generated report that provides information regarding recent usages of a password/passcode associated with the password/passcode change event.

9. The method of claim 1, further comprising:
providing an automated interface through which a user is able to enter a user defined message;
receiving a user defined message for a user via the automated interface;
storing the received user defined message in a manner indexed to the user in the data store, wherein the stored message is the pre-existing message.

10. The method of claim 9, wherein the automated interface is a user interface able to exchange digital content over an Internet with a network element.

11. The method of claim 9, wherein the automated interface is a Web interface accessible via a Web browser.

12. The method of claim 9, wherein the automated interface is a voice user interface of an interactive voice response system.

13. The method of claim 1, wherein said steps of claim 1 are performed by at least one machine in accordance with at least one computer program stored in a computer readable media, said computer programming having a plurality of code sections that are executable by the at least one machine.

14. A security system comprising:
a notification configuration interface configured to permit a set of users to enter user specific messages, which are to be automatically presented to each of the users responsive to an occurrence of a password/passcode change event;
a notification data store configured to store and maintain user specific messages entered via the notification configuration interface; and
a notification engine configured to automatically detect a password change event, to determine a set of affected users, and to convey password change notices to the set of affected users, where each of the password change notices includes a user specific message provided by an associated user.

15. The system of claim 14, wherein the notification configuration interface is a user interface able to exchange digital content over an Internet with a network element communicatively linked to the security system.

16. The system of claim 14, wherein the notification configuration interface is at least one of a Web interface renderable within a standard Web browser and voice user interface of an interactive voice response system.

17. The system of claim 14, wherein the notification engine delivers the change notices to a user established delivery address using a user defined delivery mechanism selected from one of email, postal mail, a telephone communication, and a facsimile message.

18. The security system of claim 14, further comprising:
an activity monitor configured to automatically generate activity reports that provide information regarding recent usages of a password/passcode associated with the password/passcode change event.

19. The security system of claim 18, wherein the activity monitor is configured to present automatically generated activity reports to an authorized user before a password/passcode is changed.

20. The security system of claim 18, wherein at least a portion of the change notices include activity reports automatically generated by the activity monitor.
